(19) United States
(12) Patent Application Publication
(10) Pub. No.: US 2014/0238829 A1
(43) Pub. Date: Aug. 28, 2014

(54) Shaft Slip-Off Stopping Structure And Switch Having The Same

(71) Applicant: TOYO DENSO KABUSHIKI KAISHA, Tokyo (JP)

(72) Inventors: Yukiyoshi TAKATSU, Tsurugashima-shi (JP); Shingo MIYAYAMA, Tsurugashima-shi (JP)

(73) Assignee: TOYO DENSO KABUSHIKI KAISHA, Tokyo (JP)

(21) Appl. No.: 14/186,234

(22) Filed: Feb. 21, 2014

(30) Foreign Application Priority Data
Feb. 28, 2013 (JP) 2013-38288

(51) Int. Cl. G05G 1/12; H01H 9/00

(52) U.S. Cl. CPC G05G 1/12; H01H 9/00
USPC 200/237; 74/548

(57) ABSTRACT

Disclosed is a shaft inserted member into which a shaft is inserted in a relatively movable manner, and a locking mechanism provided in the shaft inserted member. The tip portion of the shaft includes a locking step portion formed by providing an annular groove or a ring-shaped projection portion. The locking mechanism includes at least two locking pieces arranged around the shaft at an equal interval. The shaft is stopped from slipping off by a tip portion of each of the tip locking portions abutting on the locking step portion. The locking piece can receive the force in a pulling direction in a length direction of the locking piece, whereby a load can be reduced. That is, sufficient strength can be maintained.

### FIELD OF THE INVENTION

The field relates to a shaft slip-off stopping structure and a switch having the shaft slip-off stopping structure.

### BACKGROUND OF THE INVENTION

In JP 58-27453 Y, there is disclosed a structure (hereinafter referred to as a first conventional structure) in which a shaft, which is bifurcated and can be tapered by narrowing down a space therein, is elastically returned after passing through a hole in a body and is stopped from slipping off by a slip-off stopping lock provided at a tip portion thereof.

In JP 3796051 B, there is described a structure (hereinafter referred to as a second conventional structure) in which a shaft is provided with an arrowhead shaped engaging projection part at a tip thereof, and by closing a slit formed inside the engaging projection part, the shaft is configured to pass through an axis insertion hole in an elastically returnable manner.

Furthermore, in JP 4548911 B, there is introduced a structure (hereinafter referred to as a third conventional structure) in which a mushroom-shaped motor shaft has an abutting end part and a small-diameter shaft, and the abutting end part thereof is supported by a thrust washer. At this time, inside a small-diameter groove part surrounding the small-diameter shaft in a circumferential direction, there is a clip facing to stop the abutting end part from slipping off.

This clip includes four extension parts projecting out from a tubular base part toward a center in a transverse direction (a shaft-crossing direction). Each of the extension parts is elastically deformable, and by a tip of each of the extension parts, a space having a smaller diameter than that of the abutting end part is partitioned at the center.

Each of the extension parts, being pushed against the abutting end part, is deformed to allow for passage of the abutting end part, and is elastically returned after the passage so as to be engaged when the abutting end part is pulled up.

In other words, it is configured not to be engaged when it is supported by the thrust washer.

There are problems with the conventional structures, which are discussed as follows.

Since the shaft is bifurcated (and there is a wide space between the bifurcated parts) in the first conventional structure, there is a fear that overall shaft strength may be insufficient. It has a disadvantage in that the shaft may easily slip off in a case where one of the bifurcated parts of the shaft is damaged

The engaging projection part according to the second conventional structure is divided into two parts by the existence of a slit. Therefore, similar to the problem in the first conventional structure, there is a problem of insufficient strength and in that it may easily slip off.

The clip according to the third conventional structure is not related to a rotation of the shaft in the first place. The thrust washer is playing that role.

Therefore, there is a problem in that the number of components is increased.

Furthermore, it is necessary for the clip projecting in the transverse direction to receive a force from the shaft in a direction of pulling out with a thickness direction thereof.

There remains a need for improved shaft slip-off stopping structures and switches having such structures.

### SUMMARY OF THE INVENTION

In view of the above-described problems of the prior art, as discussed in the above-referenced background, the present invention aims at providing a shaft slip-off stopping structure, which has sufficient strength, is difficult to be pulled out, and further can be constituted with the minimum number of components, and a switch having the same.

To solve the above-described problems, the present invention has the following exemplary configuration.

Note that a definition of a term and the like provided for describing any of the aspects of the present invention shall also be applied to another aspect of the present invention where possible, regardless of an order of description.

Characteristics of the present invention according to a first aspect

A shaft slip-off stopping structure according to a first aspect of the present invention includes: a shaft inserted member into which a shaft is inserted in a relatively movable manner; and a locking mechanism provided in the shaft inserted member, the shaft slip-off stopping structure being configured between a tip portion of the shaft and the locking mechanism in a direction opposite to an insertion direction, wherein the tip portion of the shaft includes a locking step portion formed by providing an annular groove or a ring-shaped projection portion, the locking mechanism includes at least two locking pieces arranged around the shaft at an equal interval, each of the locking pieces includes a base part extending along a length direction of the shaft, and a tip locking portion bending from the base part and extending toward a center direction, and the shaft is stopped from slipping off by a tip portion of each of the tip locking portions abutting on the locking step portion.

### CHARACTERISTICS OF THE PRESENT INVENTION ACCORDING TO A SECOND ASPECT

A switch according to a second aspect of the present invention (hereinafter referred to as a switch in the second aspect as appropriate) is the switch having a structure according to the first aspect. The switch includes: an operation part integrally provided in a base end portion on an opposite side of the tip portion of the shaft; and a switch main body inside which the shaft inserted member is provided.

### CHARACTERISTICS OF THE PRESENT INVENTION ACCORDING TO A THIRD ASPECT

A switch according to a third aspect of the present invention (hereinafter referred to as a switch in the third aspect as appropriate) is the switch according to the second aspect wherein the shaft is configured to be rotatable relative to the switch main body and the locking mechanism by operation of the operation part.

### CHARACTERISTICS OF THE PRESENT INVENTION ACCORDING TO A FOURTH ASPECT

A switch according to a fourth aspect of the present invention (hereinafter referred to as a switch in the fourth aspect as appropriate) is the switch according to the second aspect wherein the shaft is configured to be retractable relative to the switch main body and the locking mechanism by operation of the operation part.

### CHARACTERISTICS OF THE PRESENT INVENTION ACCORDING TO A FIFTH ASPECT

A switch according to a fifth aspect of the present invention (hereinafter referred to as a switch in the fifth aspect as appropriate) the switch according to the fourth aspect wherein the shaft inserted member has a movable contact point configured to move in link with retraction of the shaft.

According to one example of the present invention, a slip-off stopping structure and a switch having the same can be provided with sufficient strength, can be made to be difficult to slip off, and further can be constituted with the minimum number of components.

Therefore, it is no longer necessary to use a conventionally-used slip-off stopping member such as an E-ring, for example, whereby it is possible to save labor and reduce costs in manufacturing.

### BRIEF DESCRIPTION OF THE DRAWINGS

Further features and advantages of the invention will become apparent from reading the following detailed description in conjunction with the following drawings, in which like reference numbers refer to like parts:

FIG. 1 is a longitudinal sectional view of a switch (sectional view taken along A-A in FIG. 2);

FIG. 2 is a planar view of the switch;

FIG. 3 is an exploded perspective view of the switch;

FIG. 4 is a planar view of a switch main body;

FIG. 5 is a bottom view of the switch main body;

FIG. 6 is an enlarged view of a shaft slip-off stopping structure illustrated in FIG. 1;

FIG. 7 is a sectional view of the assembled switch according to a modification;

FIG. 8 is a perspective view illustrating a structure around a shaft of the switch illustrated in FIGS. 7; and

FIG. 9 is a perspective view of a movable member viewed from below.

### DETAILED DESCRIPTION

The examples and drawings provided in the detailed description are merely examples, and should not be used to limit the scope of the claims in any claim construction or interpretation.

An embodiment for carrying out the present invention (hereinafter referred to as this embodiment) is described with reference to the drawings.

In this embodiment, a switch is given as an applicable example of a shaft slip-off stopping structure.

The switch given herein falls into two types, one is a rotary type switch and other is a push type switch.

### SCHEMATIC STRUCTURE OF THE ROTARY TYPE SWITCH

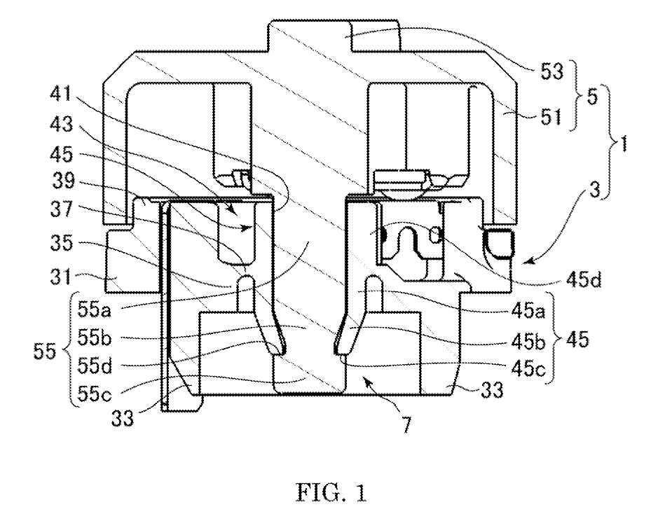

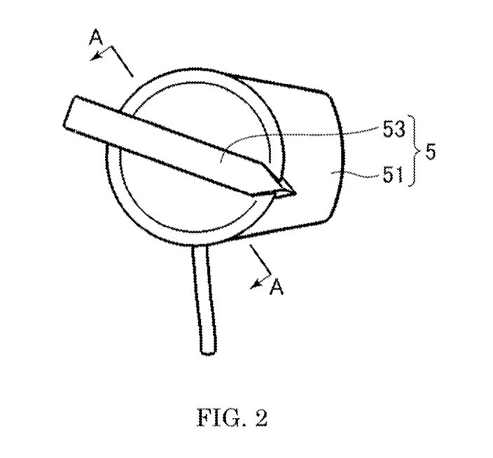

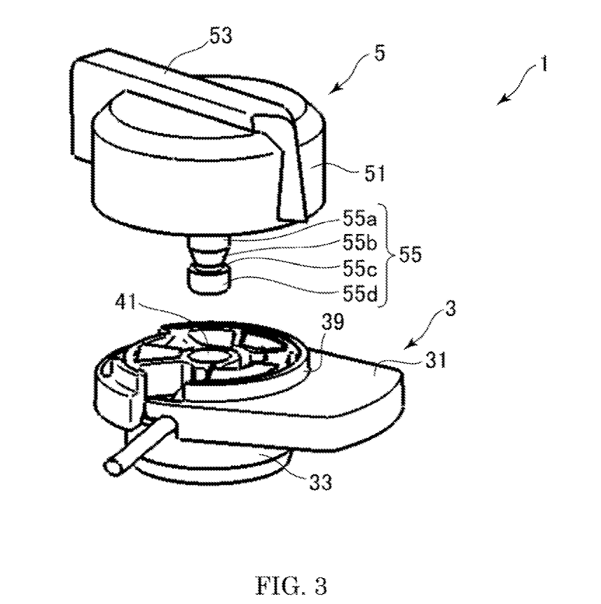

As illustrated in FIGS. 1 and 3, a switch 1 is a rotary type switch schematically including a resin switch main body 3 and a resin operation part 5 rotatably integrated into the switch main body 3.

### SCHEMATIC STRUCTURE OF THE SWITCH MAIN BODY

As illustrated in FIG. 1 and FIGS. 3 to 4, the switch main body 3 includes: a flange part 31 serving as a base; a cylindrical partition wall 33 projecting downward from an undersurface of the flange part 31; a thick plate portion 35 extending from inside the cylindrical partition wall 33 toward a center; and a locking mechanism 43 supported by a thin plate portion 37 extending further toward the center from the thick plate portion 35.

The locking mechanism 43, as described below, constitutes a part on a side of the switch main body 3 to be a part of a shaft slip-off stopping structure 7.

On the other hand, on an upper surface of the flange part 31, a flat cylindrical part 39 on which a terminal for controlling a switch function and the like is provided, and an axis insertion hole 41 penetrates a center thereof.

The switch main body 3 can be wholly constituted by integral molding.

Since the switch main body 3 is a member in which the locking mechanism 43 is provided, it has a meaning as a shaft inserted member.

### SCHEMATIC STRUCTURE OF THE OPERATION PART

As illustrated in FIGS, 1 to 3, the operation part 5 externally includes: a substantially cylindrical operation part main body 51; and an arrow-shaped instruction part 53 provided so as to traverse a top face of the operation part main body 51.

The arrow-shaped instruction part 53 is a part for selectively indicating if the switch 1 is on or off.

### SHAFT SLIP-OFF STOPPING STRUCTURE ON THE SHAFT SIDE

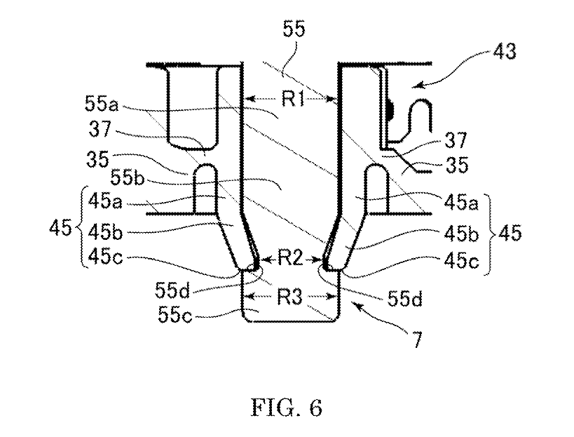

As illustrated in FIGS. 1 and 6, a shaft 55 projecting in a direction of the switch main body 3 is integrally formed in a central part on a back side of the operation part main body 51.

The shaft 55 includes toward a tip thereof in order: a base shaft portion 55a having a diameter R1 and projecting from the operation part 5 (operation part main body 51); a tapered portion 55b in which the diameter R1 is gradually reduced to a diameter R2 (R2<R1); and a locking portion 55c having a diameter R3 (R3>R2, R3=R1 in this embodiment).

Since diameters are different between adjacent parts in this way (and an annular groove is formed), a locking step portion 55d is formed between the tapered portion 55b, being a tip portion of the shaft 55, and the locking portion 55c.

The locking step portion 55d constitutes a part on the shaft 55 side in the shaft slip-off stopping structure 7.

### SHAFT SLIP-OFF STOPPING STRUCTURE ON THE SWITCH MAIN BODY SIDE

As illustrated in FIG. 1 and FIGS. 4 to 6, the locking mechanism 43 includes a plurality of locking pieces 45 supported by the thick plate portion 35.

At least two locking pieces 45 may be provided. In this embodiment, there are provided four locking pieces of the same type positioned at an equal interval in a circumferential direction.

It is preferable that each of the locking pieces 45 have elasticity.

Each of the locking pieces 45 having elasticity, by using elastic force thereof, can rotatably and elastically clamp the shaft 55 in a cooperative manner.

A space surrounded by each of the locking pieces 45 is substantially concentric with the axis insertion hole 41.

The locking piece 45 is a plate-shaped member having a doglegged section, and includes a base shaft clamping portion (base part) 45a and a taper clamping portion (tip locking portion) 45b.

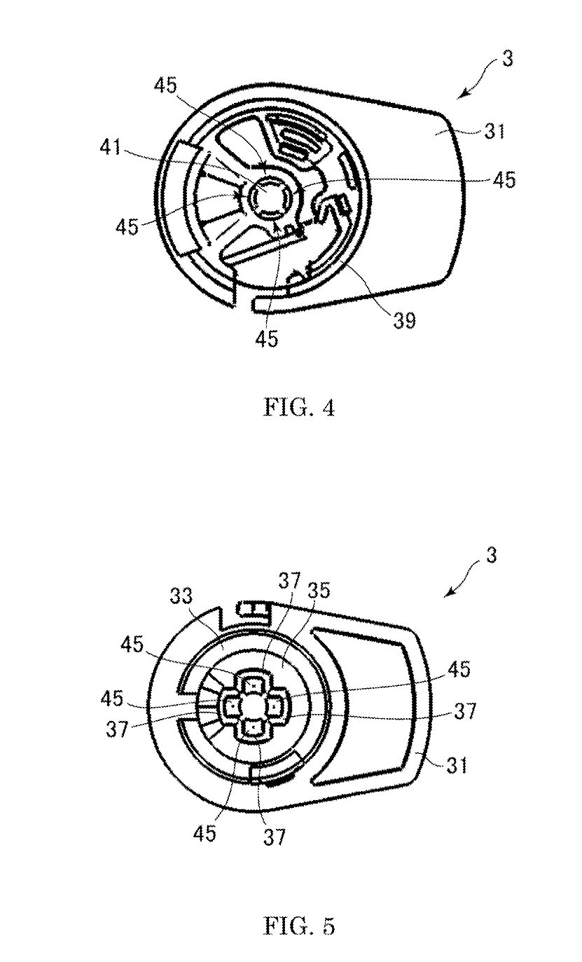

As illustrated in FIGS. 1 and 4, an inner surface of the base shaft clamping portion 45a is formed into a shape along an outer periphery surface of the base shaft portion 55a of the shaft 55, and an inner surface of the taper clamping portion 45b is formed into a shape along the tapered portion 55b, respectively (that is, formed into a curved surface having substantially the same curvature as the shaft 55).

This is for making rotation (relative move) of the shaft 55 inserted through the axis insertion hole 41 smooth, and further for increasing an effect of suppressing axial deflection by increasing a contact area between the two as much as possible.

Therefore, an upper part 45d of the base shaft clamping portion 45a functions as a bearing structure for supporting the shaft 55 penetrating therein without hindering the rotation thereof.

Note that an open end of the taper clamping portion 45b forms a tip portion 45c.

The locking piece 45 is configured to be elastically deformable as a whole. Accordingly, the locking piece 45 can cooperatively damp the shaft 55 while allowing the rotation thereof.

That is, as illustrated in FIG. 6, a distance between the opposing base shaft clamping portions 45a is arranged to be slightly shorter than the largest diameter of the shaft 55 (e.g., diameter R1). Accordingly, the shaft 55 is inserted by slightly expanding the distance therebetween.

Elasticity of the locking piece 45 allows for this expanding.

Furthermore, the shortest distance between the taper clamping portions 45b is shorter than the distance between the base shaft clamping portions 45a, whereby the locking portion 55c of the shaft 55 largely expands the distance and passes therethrough.

After the passage, the taper clamping portion 45b is elastically returned and returns to an original position.

At that time, by a distance between the tip portions 45c becoming shorter than the diameter R3 of the locking portion 55c, the tip portion 45c engages with the locking step portion 55d formed between the locking portion 55c and the tapered portion 55b, whereby slip-off stopping is performed.

Note that, in FIGS. 1 and 6, the slip-off stopping is performed in a state where the tip portion 45c abuts on the locking step portion 55d; however, there may be a slight gap between the two.

in that case, the tip portion 45c abuts when the shaft 55 is moved in a pulling out direction.

### FUNCTIONS AND EFFECTS UNIQUE TO THIS EMBODIMENT

Following functions and effects are generated by the switch 1 according to this embodiment.

First, the shaft 55 is molded integrally with the operation part 5 (operation part main body 51), whereby it can be manufactured in one shot, and the number of components can be decreased.

Therefore, it is possible to reduce a component cost.

Furthermore, the switch 1 can be assembled only by inserting the shaft 55 into the axis insertion hole 41 of the switch main body 3 while holding the operation part 5, and by pressing it against the elastic force of the locking piece 45.

It is very easy because the slip-off stopping is performed in a direction opposite to an insertion direction by cooperation of the locking piece 45 and the shaft 55 while cancelation of the slip-off stopping is prevented by the elastic force.

Therefore, it is also possible to reduce as labor cost

Furthermore, since the locking piece 45 elastically clamps the shaft 55 in the cooperative manner, it contributes to a stable rotation, and a length direction (vertical direction in FIG. 6) thereof is substantially parallel to the pulling out direction of the shaft 55.

Accordingly, the force received in a thickness direction in the above-described third conventional structure can be received in a length direction, whereby a load can be reduced.

In other words, sufficient strength can be maintained.

### MODIFICATION ACCORDING TO THIS EMBODIMENT AND OVERALL STRUCTURE

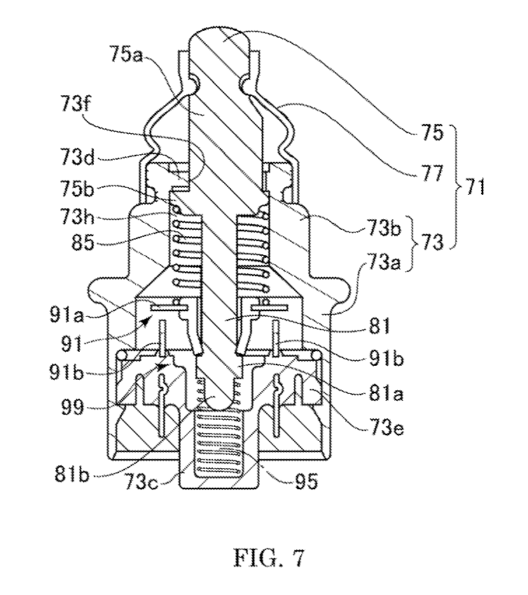

A switch 71 illustrated in FIGS. 7 and 8 is a push type switch externally including a switch main body 73, an operation part 75 retractably (relatively movably) integrated into the switch main body 73, and a cover member 77.

The cover member 77 is fixed to the switch main body 73, and is constituted so as to cover the switch main body 73 in a state where the operation part 75 is exposed from a conical apex.

The switch 71 is retracted into the switch main body 73 when the operation part 75 is pressed down with a finger, and is returned when the finger is released.

### STRUCTURE AROUND THE OPERATION PART

First, a structure around the operation part 75 is described.

As illustrated in FIGS. 7 and 8, the operation part 75 is formed to be a short length cylindrical shape. A cylinder part 75a having substantially the same diameter as the operation part 75, a ring-shaped flange part 75b having a larger diameter than that of the cylinder part 75a, and a shaft 81 having a smaller diameter than that of the ring-shaped flange part 75b (and a smaller diameter than that of the cylinder part 75a) are made of resin and are integrally molded to be concentric with each other.

A reference numeral 91 illustrated in FIGS. 7 to 9 denotes a movable member (shaft inserted member) integrally molded from resin.

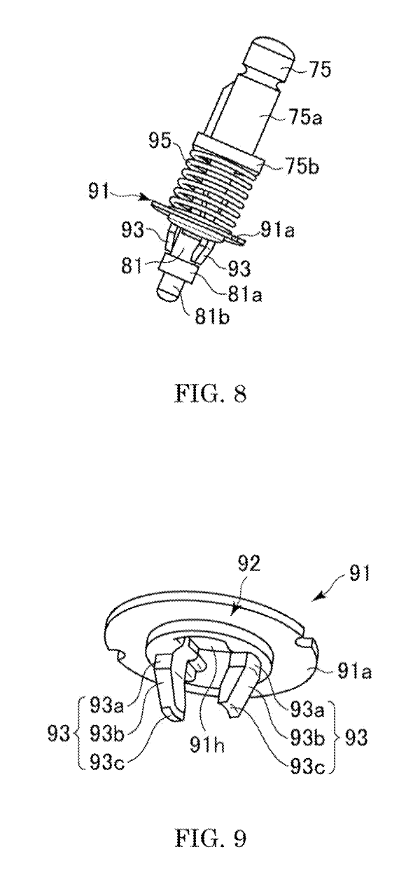

The movable member 91 includes a metal movable contact point 91a having a circular center hole at the center thereof, a ring member 92 embedded into this center hole, and a plurality of (two in this modification) locking pieces 93 projecting out from one surface (undersurface in FIG. 9) of the ring member 92.

Each of the locking pieces 93 includes a base part 93a extending along a length direction of the shaft 81, and a tip locking portion 93b bending from a tip of the base part 93a and extending toward a center direction, and it is formed into a chevron shape as a whole.

Note that a through hole 91h, penetrating through a center of the ring member 92, has an inside diameter slightly smaller than an outside diameter of the shaft 81 described below. The elastic locking piece 93, by being elastically deformed, is constituted so as to allow insertion and slide in an axial direction of a flange part 81a during the insertion.

The above-described locking pieces 93 and the flange part 81a described below constitute a slip-off stopping structure 99 for preventing the shaft from slipping off in a direction opposite to an insertion direction (upward direction in FIG. 7) from the movable member 91 (FIG. 7).

### STRUCTURE OF SWITCH MAIN BODY

As illustrated in FIG. 7, the switch main body 73 substantially includes a large diameter portion 73a and a small-diameter portion 73b above it, both of which are cylindrically shaped and concentric.

A spring receiving part 73c is provided so as to penetrate through a center of a bottom of the large-diameter portion 73a, and a small-diameter coil spring 95 is housed therein so as to be extensible and contractive in an axial direction.

An inside diameter of the small-diameter coil spring 95 is smaller than that of a tip portion Kb of the shaft 81, and an outside diameter thereof is formed to be smaller than that of the flange part 81a. Accordingly, the tip portion 81b can be inserted therein but cannot be moved above the flange part 81a.

At a central part of the switch main body 73, a vertical hole 73h through which the shaft 81 is penetrated is formed. The vertical hole 73h and the spring receiving part 73c are communicated inside.

At the top of the vertical hole 73h, there is provided a ring-shaped projection portion 73d having a through hole 73f at the center thereof.

An inside diameter of the through hole 73f is formed to be an inside diameter that allows a move of the cylinder part 75a of the operation part 75 in an axial direction. Accordingly, the ring-shaped projection portion 73d, through the cylinder part 75a, functions as a bearing structure for supporting the entire shaft 81 to be movable back and forth.

Note that a reference numeral 85 illustrated in FIG. 7 denotes a large-diameter coil spring surrounding the shaft 81 and being clamped between the ring-shaped flange part 75b and the movable contact point 91a.

A lower end of the large-diameter coil spring 85 is fixed to the movable contact point 91a.

Inside the large-diameter portion 73a of the switch main body 73, a contact point supporting stand 73e is provided. On an upper surface of the contact point supporting stand 73e, a pair of fixed contact points 91b and 9n, each having an upper part thereof exposed, is supported.

Each of the fixed contact points 91b and 91b is arranged to a position contactable with the movable contact point 91a that has moved down.

### MODIFICATION AND, FUNCTIONS AND EFFECTS OF THIS EMBODIMENT

As illustrated in FIGS. 7 to 9, when an operator presses the operation part 75 down with a finger, the small-diameter coil spring 95 is compressed, and when the operator releases the finger, the operation part 75 is returned by elastic return of the small-diameter coil spring 95.

On the other hand, this pressing down causes the large-diameter coil spring 85 to be pushed down through the ring-shaped flange part 75b, whereby the movable contact point 91a is moved down accompanied by this.

The movable contact point 91a that has moved down eventually contacts the fixed contact points 91b, and furthermore, by compression accompanying the moving down of the large-diameter coil spring 85, is elastically pressed against the fixed contact points 91b.

The elastic pressing ensures contact between both of the fixed contact point 9n and the movable contact point 91a. Accordingly, one of the fixed contact points 91b and the other of the fixed contact points 91b are electrically connected, and the switch 71 is turned on.

It is returned to an original state by the operator releasing the finger as described above, and the on state is turned into an off state.

The slip-off stopping in the direction opposite to the insertion direction is performed by cooperation between the locking piece 93 and the shaft 81, whereby it has a very simple structure but a large effect.

The scope of the claims should not be limited by the preferred embodiments and examples, but should be given the broadest interpretation consistent with the specification as a whole.

What is claimed is:

1. A shaft slip-off stopping structure comprising:
(a) a shaft inserted member into which a shaft is inserted in a relatively movable manner; and
(b) a locking mechanism provided in the shaft inserted member,
(c) the shaft slip-off stopping structure being configured between a tip portion of the shaft and the locking mechanism in a direction opposite to an insertion direction, wherein the tip portion of the shaft includes a locking step portion formed by providing an annular groove or a ring-shaped projection portion, the locking mechanism includes at least two locking pieces arranged around the shaft at an equal interval, and each of the locking pieces includes a base part extending along a length direction of the shaft, and a tip locking portion bending from the base part and extending toward a center direction, and the shaft is stopped from slipping off by a tip portion of each of the tip locking portions abutting on the locking step portion.

2. A switch having the shaft slip-off stopping structure according to claim 1, comprising:
(a) an operation part integrally provided in a base end portion on an opposite side of the tip portion of the shaft; and
(b) a switch main body inside which the shaft inserted member is provided.

3. The switch according to claim 2, wherein the shaft is configured to be rotatable relative to the switch main body and the locking mechanism by operation of the operation part.

4. The switch according to claim 2, wherein the shaft is configured to be retractable relative to the switch main body and the locking mechanism by operation of the operation part.

5. The switch according to claim 4, wherein the shaft inserted member has a movable contact point configured to move in link with retraction of the shaft.
